(19) United States
(12) Patent Application Publication
(10) Pub. No.: US 2010/0060010 A1
(43) Pub. Date: Mar. 11, 2010

(54) Ecology friendly compound energy unit

(76) Inventors: Iosif Gaportsin, Staten Island, NY (US); Yulia Freynk, Brocklyn, NY (US)

Correspondence Address: Iosif Gaportsin, 70 New Lane, Apt. 3N, Staten Island, NY, 10305, US

(21) Appl. No.: 12/283,032

(22) Filed: Sep. 10, 2008

(51) Int. Cl. F03D 9/00

(52) U.S. Cl. 290/55

(57) ABSTRACT

The ecology friendly compound energy unit for generating electric power from wind, convection (stack effect) and solar energy includes a warm/hot air/gas vertical pipe and a cyclone mounted on the top of the warm/hot air/gas vertical pipe, and constituted by a group of trumped—shaped bodies situated a round a vertical axis. An electrical generator with a propeller for conversion of electrical energy from kinetic energy of the air/gas flow is located at the top of the vertical air/gas pipe and is covered by photovoltaic modules, which convert sunlight directly into electricity. The unit allows to produce electricity with no noise, no air pollution, and no moving parts excluding a generator while using clean renewable resources.

### BACKGROUND OF THE INVENTION

The present invention relates to wind, convection and solar electric power stations, and also to a power sources for the same.

There are a lot of places, where surplus hot air/gas, are produced. However, today the surplus hot air/gas is not used and it discharged through conduits to atmosphere. For example, it is discharged from boiler rooms of buildings, from machine rooms of different ships, in places where gas, oil, condensate etc. are extracted, through chimney towers.

The kinetic energy of blowing wind has long been converted to mechanical energy. Many different wind driven devices have been proposed and used for taking energy from wind and transforming it into mechanical or electrical power. Such devices as a windmills are large, cumbersome and expensive when compared to the amount of useful work they produce. They have a multitude of very large blades which are directly driven by wind which contacts them, the velocity of which is often so low that the blades can not move the load.

Another common type of windmill is a generally spherical “turbine” type rotor used widely on houses to evacuate hot air from attics, garages, and boiler room. These rotors have multiple blade set at an angle to catch the wind at one side and deflect the wind at the other side.

Again, they are quite suitable for their intended purpose, but they are activated by the wind at its normal velocity and produce so little power that they can not drive any appreciable load.

A major drawback of the windmill type devices is that in order to harness enough energy to drive an electric generator, the windmill has to be excessively large and located in an area of high constant wind.

The size of the conventional blades results in a constant chopping sound which is distracting and becomes unpleasant and uncomfortable after a short period of time of operation.

To produce optimum results wind driven devices should be rapidly responsive to changes in wind direction and velocity characteristics not commonly shared by prior art devices.

Another type of systems for the obtaining of energy by means of air/gas flows is a system which is similar to a natural cyclone that permits coverage of the whole range of power required by people, however it can be installed in any location.

The energy obtained with the system is produced by an artificial reproduction in suitable structures of confined vortices having a cyclonic configuration from the kinetic energy originating from flows or by taking advantage of the pressure differences existing in the atmosphere as well as the components due to the thermal gradients existing therein.

Optimally, and especially with electrical generating wind driven devices, such devices could integrate a few streams of different gasses which originate from separate sources.

This system permits known phenomena such as cyclones, tornados, typhoons, whirlwinds, etc., to be reproduced by analog and allows to produce the electrical energy.

Examples of gas/air flow powered electrical generators are shown in:

U.S. Pat. No. 5,284,628 issued to Prueitt and Melvin discloses convection towers which are capable of cleaning the pollution from large quantities of air and of generating electricity utilizing the evaporation of water sprayed into the towers to create strong airflows.

U.S. Pat. No. 5,038,049, issued to Kato and Shuichi, discloses a vertical axis wind powered generator.

U.S. Pat. No. 4,452,046, issued to Valentin and Zapata, discloses the system for obtaining energy by fluid flows resembling a natural cyclone or anticyclone.

### SUMMARY OF THE INVENTION

The present invention concerns an apparatus for generating electric power from wind and convection flows, in which a wind air flow is directed through a cyclonic machine and then combined with a convection flow. It permits reach very high degrees of energy concentration.

One of the fundamental elements for the artificial production of cyclones is constituted by the convectors composed of two vertical membranes, with one of the being almost tangential to a central cylindrical duct, to follow a curved profile in such a way that their presence, together with the central duct, causes in the flow an acceleration defined by the laws of aerodynamics, compelling the natural wind to increase its velocity and acceleration.

A secondary, but important aspect is the possibility to obtain extra energy, using photovoltaic modules, as a cover for described compounded energy unit.

The cyclonic conversion is characterized in that; it transforms horizontal energy flow into vertical energy flows, absorbing in the vertical flow other flows originating from other energy sources, such as excessive warm air (stack effect).

For the description of the system, we will make use of a concrete example of the design to which there correspond the enclosed figures presented as embodiments, which are not intended to be limiting since the specific data in each case are in accordance with the requirements of the design, without the modifications in detail affecting the essence protected in a general manner by the present registration.

### BRIEF DESCRIPTION OF THE DRAWINGS

The above as well as other advantages of the present invention, will become readily apparent to those skilled in the art from the following detailed description of a preferred embodiment when considered in the seven of the accompanying drawings in which:

FIG. 1a is a cross sectional view of an apparatus in accordance with the invention taken along the line A-A in FIG. 2.

FIG. 1b shows a location and geometry of inlet openings on a compound energy unit body;

FIG. 2 is a cross-sectional view of the apparatus taken along the broken line B-B in FIG. 1a;

FIG. 3 shows an ecology friendly compound energy unit installed on a roof of a building;

FIG. 4 shows an ecology friendly compounded energy unit installed on a conduit of an extracted hot gas, oil or condensate;

FIG. 5 shows an ecology friendly compounded energy unit installed on the ship;

FIG. 6 shows an ecology friendly compounded energy unit installed on a chimney tower.

### DESCRIPTION OF THE PREFERRED EMBODIMENTS

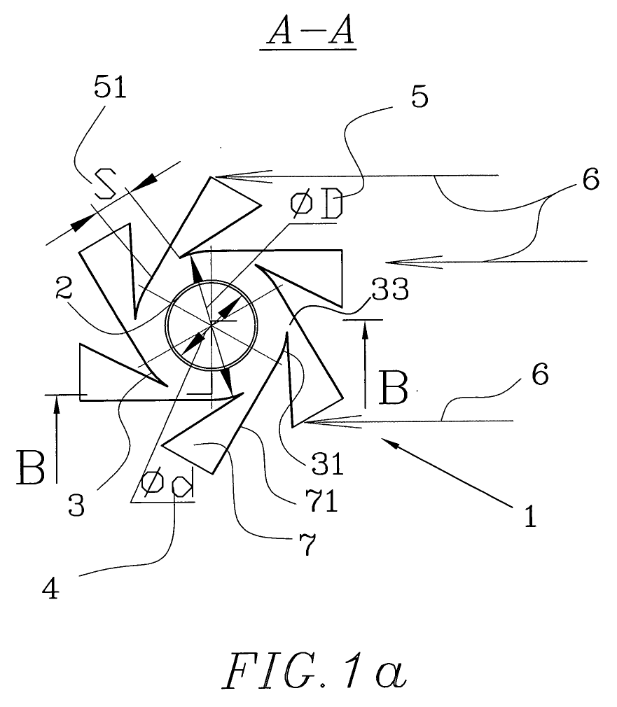

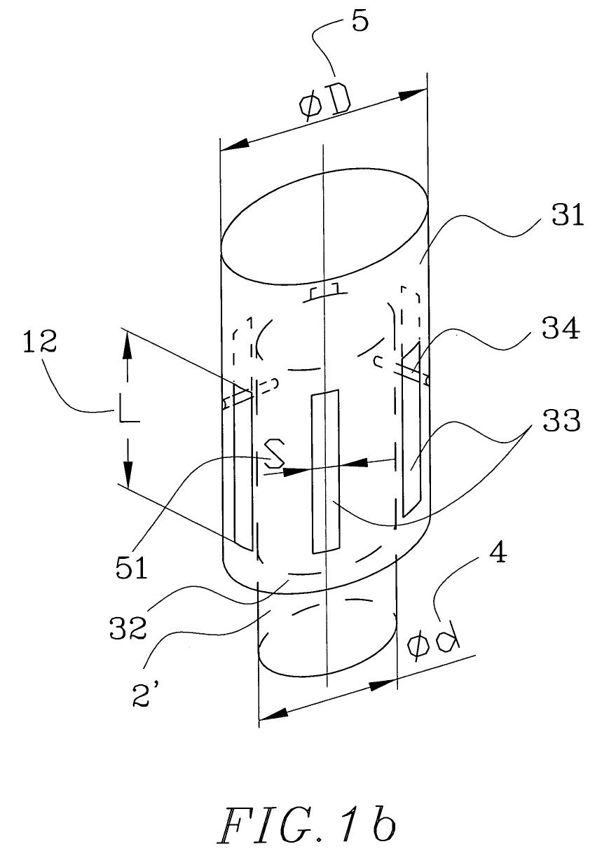

An electrical power generating ecology friendly compound energy unit (CEU) 1, in accordance with the present invention is shown in FIGS. 1a-6.

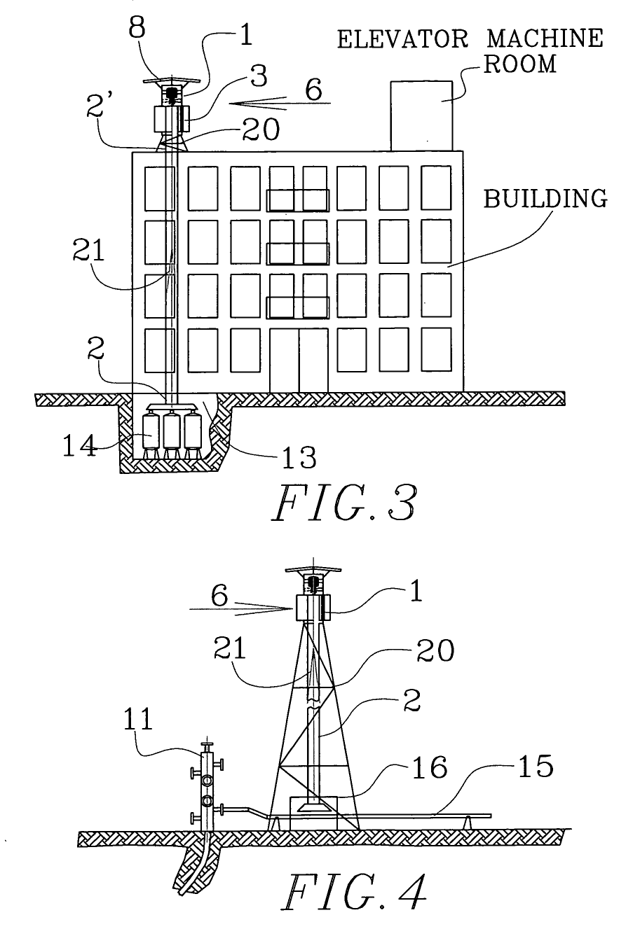

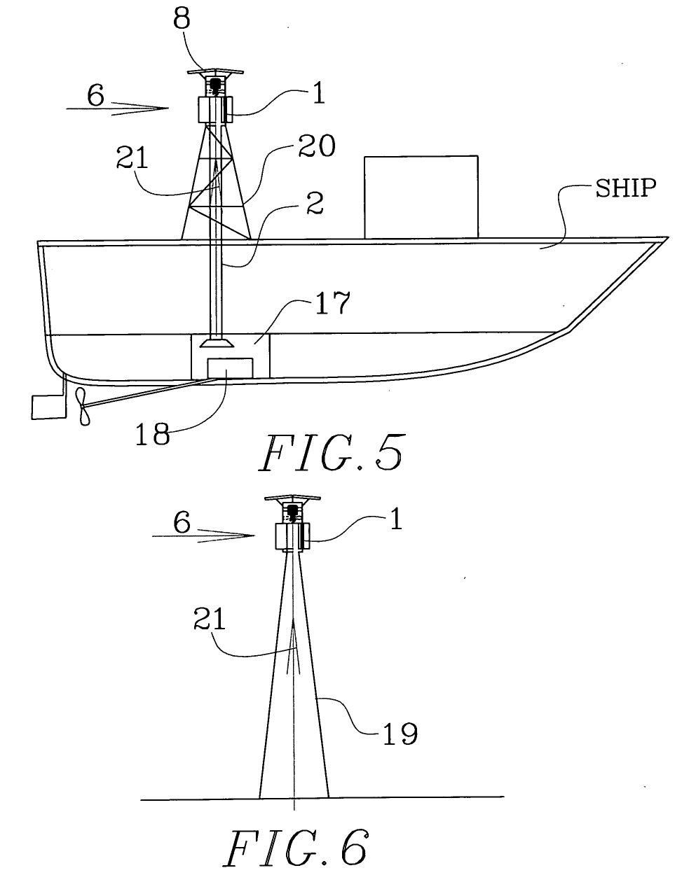

The CEU 1 comprises a pipe duct 2 for air/gas, which rises from energy sources, excessive warm air/gas source in boiler room 13 from boilers 14 (FIG. 3), a chamber 16 surrounding a conduit 15 of extracted gas, oil condensate, etc. from a well-head 11 (FIG. 4), a machine room 17 from an engine, in a ship (FIG. 5), a chimney tower 19 (FIG. 6).

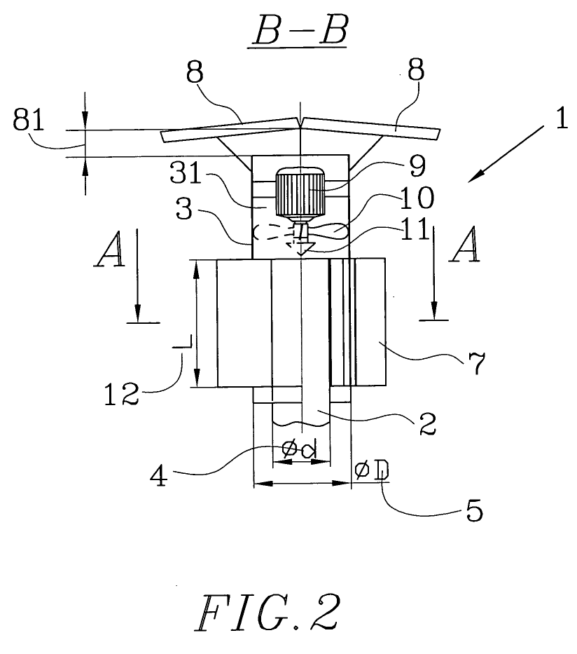

An upper part 2′ of the pipe duct 2 supports a cyclone part 3 which includes a cylindrical body 31 and a group of trumpet-shaped bodies 7 (preferable six). One wall 71 of each trumpet-shaped body 7 is tangential to a central cylindrical body 31, as shown on FIG. 1a. The cylindrical body 31 is connected with the pipe duct 2 by a bottom plate 32 and round bars 34 (FIG. 1b). It should be understood that a number of inlet openings 33 is equal to a number of the trumpet-shaped bodies 7. A generator 9 with a propeller 10 and a conical rotary dispenser 11 is installed inside the cylindrical body 31 above the end of the pipe duct 2 (FIG. 2).

Photovoltaic modules 8 cover the cylindrical body 31 with a some gap 81 therebetween from above, as a roof with a slope.

As shown in FIGS. 3, 4, 5 the compounded energy unit (CEU) 1 is supported by a structural support 20, formed for example as an open frame tower.

For calculating of design parameters of inlet openings 33 the distance—S (51) should be less than

$$\frac{D ( 5 ) - d ( 4 )}{6}$$

and length—L (12) of inlet openings 33 is calculated as a difference between area of big circle—D(5) and area of small circle—d(4) is divided by distance—S(51)

The design equation is

$$\frac{{A}_{B} - {A}_{S}}{S} = L ,$$

where
A_{B}—area of big circle—D(5)
A_{S}—area of small circle—d(4)
S—distance—(51)
L—length of inlet opening—(12) or

L=3.14×(D²−d²): 4S=0.785×(D²−d²):S.

In FIG. 1a, 3, 4, 5, 6, an arrow 6 indicates one direction of the wind entering the cyclone part 3 and an arrow 21 indicates a direction of the flow of hot air/gas from a bottom to a top of the pipe duct 2 what means convection (stack effect).

Total power could be calculated by standard formula: Q^{ws}=√Q^{w2}+Q^{s2}, where Q^{ws}—flow rate has the combined effect of wind and stack effect
Q^{W}—flow rate has wind effect
Q^{S}—flow rate has stack effect

It will be understood that each of the elements described above, or two or more together, may also find a useful application in other types of constructions differing from the types described above.

While the invention has been illustrated and described as embodied an ecology friendly compound energy unit, it is not intended to be limited to the details shown, since various modification and structural changes may be made without departing in any way from the spirit of the present invention.

Without further analysis, the forgoing will so fully reveal the gist of the present invention that other can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth the appended claims.

1. An ecology friendly compound energy unit for generating electrical power from wind, convection and solar energy comprising: a substantially vertical warm/hot air/gas vertical pipe duct extending from a source of the warm/hot air/gas towards atmosphere; a cyclone mounted on a top of the vertical pipe duct; an electric generator with a propeller installed inside a body of the cyclone and located higher than the top of the vertical pipe duct; and photovoltaic modules covering the compound energy unit.

2. The compound energy unit according to claim 1, wherein said cyclone includes a main cylindrical body and a plurality of trumpet—shaped bodies, with one vertical wall of each of the trumpet—shaped body as being tangential to a central main cylindrical body of the cyclone.

3. The compound energy unit according to claim 2, including a plurality of inlet openings with an area of each of the inlet openings being equal to a difference between an area of a section of the main cylindrical body of the cyclone and an area of a section of the vertical pipe duct.

4. The compound energy unit according to claim 1, wherein said the electric generator with the propeller also has a conical disperser.

5. The compound energy unit according to claim 1 wherein: said source of warm/hot air/gas is a source selected from the group consisting of a boiler room of a building, a machine room of a ship, a chamber mounted above a conduit of extracted hot gas, oil or condensate, a chimney tower, and combinations thereof.

6. The compound energy unit according to claim 1, wherein said photovoltaic modules cover the compound energy unit as a roof with a slope.

7. The compound energy unit according to claim 1 wherein the cyclone with the generator is supported by a structure support.
